(19) United States
(12) Patent Application Publication
(10) Pub. No.: US 2009/0054132 A1
(43) Pub. Date: Feb. 26, 2009

(54) GAMING MACHINE AND CONTROL METHOD THEREOF

(75) Inventor: Hiroki SAITO, Koto-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/186,104

(22) Filed: Aug. 5, 2008

(30) Foreign Application Priority Data
Aug. 22, 2007 (JP) 2007-215808

(51) Int. Cl. A63F 13/00

(52) U.S. Cl. 463/25

(57) ABSTRACT

A gaming machine includes a controller and gaming terminals. The controller accumulates a part of gaming media bet on a race by racehorses as a bonus count value. The controller qualifies one or more gaming terminals which meet a certain condition to participate in a bonus game. The controller assigns one or more racehorses which run in the bonus game to each qualified gaming terminal. The controller provides a whole or part of bonus count value to one or more gaming terminals to which one or more racehorses winning in the bonus game are assigned.

### CROSS REFERENCE TO RELATED APPLICATION

This application claims benefit of priority under 35 U.S.C. §119 to Japanese Patent Application No. 2007-215808, filed on Aug. 22, 2007, the entire contents of which are incorporated by reference herein.

### BACKGROUND OF THE INVENTION

1. Field of the Invention

The present invention relates to a gaming machine executing a racing game and a control method thereof.

2. Description of the Related Art

As a gaming machine executing a racing game, there are known gaming machines described in U.S. Pat. No. 6,210,275, U.S. Pat. No. 6,358,150, U.S. Pat. No. 6,450,887, Japanese Patent Application Laid-Open No. 2001-87461, Japanese Patent No. 3291287, Japanese Patent No. 3366308, U.S. Pat. No. 6,921,331, Japanese Patent Application Laid-Open No. 2002-85852, Japanese Patent Application Laid-Open No. 2002-35429, U.S. Pat. No. 7,025,353 and U.S. Pat. No. 7,172,508.

U.S. Pat. No. 6,210,275 describes a gaming machine that allows a player to bet on one or more bet types. For example, the bet type is Quinella, Exacta, Trifecta, or Superfecta. If there are not any winners in a race, the gaming machine accumulates a pool payoff value in the race as a jackpot bonus. When there are one or more winners in the following race, the gaming machine provides the jackpot bonus to the one or more winners.

Each of U.S. Pat. No. 6,358,150 and U.S. Pat. No. 6,450,887 describes a gaming machine to which wager terminals are connected via a network. The gaming machine enables parimutuel wagering with instant payoffs on actual past events.

Japanese Patent Application Laid-Open No. 2001-87461 describes a gaming machine that allows a player to bring up a character which plays a racing game. Japanese Patent No. 3291287 describes gaming machines that are online connected to each other and a management machine that integrates odds for a racing game from the gaming machines. Japanese Patent No. 3366308 describes a gaming machine that calculates odds based on a target payout rate and a winning rate and then compensates the calculated odds.

U.S. Pat. No. 6,921,331 describes a gaming machine that executes a racing game via a network. Each of Japanese Patent Application Laid-Open No. 2002-85852 and Japanese Patent Application Laid-Open No. 2002-35429 describes a gaming machine that executes a racing game in which a player brings up a character playing the racing game, via a network in a wide-area. U.S. Pat. No. 7,025,353 describes a gaming machine that executes a board game in a race. U.S. Pat. No. 7,172,508 describes a gaming machine that conducts a plurality of betting events based on events occurring during a sporting event.

However, any above-described documents do not describe execution of a bonus game that differs from the normal racing game.

### SUMMARY OF THE INVENTION

It is an object of the present invention to provide a gaming machine that executes a bonus game in which a player can obtain more gaming media when playing racing games continually, which increases player's expectation, and a control method thereof.

In order to achieve the object, the present invention provides a gaming machine that repeats a unit game in which a race by pseudo racehorses is executed and a prize is provided based on order of arrival for the pseudo racehorse, comprising: a display that displays the race by pseudo racehorses; gaming terminals that are arranged around the display and allow players to participate in the race by pseudo racehorses; a counter that accumulates a part of gaming media bet on the race by pseudo racehorses as a bonus count value when the players participate in the race by pseudo racehorses using the gaming terminals; and a controller that (a) randomly selects a unit game as a bonus game from among unit games; (b) qualifies one or more gaming terminals which meet a certain condition to participate in the bonus game; (c) assigns one or more pseudo racehorses which run in the bonus game to each qualified gaming terminal; and (d) provides a whole or part of bonus count value to one or more gaming terminals to which one or more pseudo racehorses winning in the bonus game are assigned.

According to the present invention, a part of gaming media bet on the race by pseudo racehorses is accumulated as a bonus count value and a unit game is randomly selected from among unit games as a bonus game. In the bonus game, one or more pseudo racehorses which run in the bonus game are assigned to each qualified gaming terminal. If one or more pseudo racehorses assigned to one or more gaming terminals wins in the bonus game, a whole or part of bonus count value is provided to the one or more gaming terminals. Therefore, the gaming machine can provide to a player playing at each gaming terminal an opportunity that the player obtains more gaming media.

In a preferred embodiment of the present invention, the gaming machine further comprises a side game device that executes a side game differing from the race by pseudo racehorses, wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

According to the embodiment, one or more gaming terminals not participating in the bonus game can participate in the side game when the bonus game is executed. Therefore, the gaming machine can prevent a player playing a gaming terminal not participating in the bonus game from feeling bored.

In a preferred embodiment of the present invention, the side game includes a sub-game in which each gaming terminal not participating in the bonus game predicts one or more winning pseudo racehorses from among pseudo racehorses to be running in the bonus game when the bonus game is executed.

According to the embodiment, in the sub-game, although a player playing a gaming terminal not participating in the bonus game can not obtain a whole or part of bonus count value, he/she can participate in the bonus game as a normal unit game. Therefore, the gaming machine can prevent a player playing a gaming terminal not participating in the bonus game from feeling bored.

In order to achieve the object, the present invention provides a gaming machine that repeats a unit game in which a race by pseudo racehorses is executed and a prize is provided based on order of arrival for the pseudo racehorse, comprising: a display that displays the race by pseudo racehorses; gaming terminals that are arranged around the display and allow players to participate in the race by pseudo racehorses; a counter that accumulates a part of gaming media bet on the race by pseudo racehorses as a bonus count value when the players participate in the race by pseudo racehorses using the gaming terminals; and a controller that (a) randomly selects a unit game as a bonus game from among unit games; (b) qualifies one or more gaming terminals which bet on the previous race by pseudo racehorses to participate in the bonus game; (c) assigns one or more pseudo racehorses which run in the bonus game to each qualified gaming terminal; and (d) provides a whole or part of bonus count value to one or more gaming terminals to which one or more pseudo racehorses winning in the bonus game are assigned.

According to the present invention, a part of gaming media bet on the race by pseudo racehorses is accumulated as a bonus count value, a unit game is randomly selected from among unit games as a bonus game, and one or more gaming terminals which bet on the previous race by pseudo racehorses are qualified to participate in the bonus game. In the bonus game, one or more pseudo racehorses which run in the bonus game are assigned to each qualified gaming terminal. If one or more pseudo racehorses assigned to one or more gaming terminals wins in the bonus game, a whole or part of bonus count value is provided to the one or more gaming terminals. Therefore, the gaming machine can provide to a player playing at each gaming terminal an opportunity that the player obtains more gaming media.

In a preferred embodiment of the present invention, the gaming machine further comprises a side game device that executes a side game differing from the race by pseudo racehorses, wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

According to the embodiment, one or more gaming terminals not participating in the bonus game can participate in the side game when the bonus game is executed. Therefore, the gaming machine can prevent a player playing a gaming terminal not participating in the bonus game from feeling bored.

In a preferred embodiment of the present invention, the side game includes a sub-game in which each gaming terminal not participating in the bonus game predicts one or more winning pseudo racehorses from among pseudo racehorses to be running in the bonus game when the bonus game is executed.

According to the embodiment, in the sub-game, although a player playing a gaming terminal not participating in the bonus game can not obtain a whole or part of bonus count value, he/she can participate in the bonus game as a normal unit game. Therefore, the gaming machine can prevent a player playing a gaming terminal not participating in the bonus game from feeling bored.

In a preferred embodiment of the present invention, the controller qualifies one or more gaming terminals which bet more gaming media on the previous race by pseudo racehorses to participate in the bonus game, when the number of gaming terminals that bet on the previous race is more than the number of pseudo racehorses that run in the bonus game.

According to the embodiment, when the number of gaming terminals that bet on the previous race is more than the number of pseudo racehorses that run in the bonus game, one or more gaming terminals which bet more gaming media on the previous race by pseudo racehorses are preferentially qualified to participate in the bonus game. Therefore, the gaming machine can provide to a player playing at each gaming terminal an incentive that the player bets more gaming media on the race.

In a preferred embodiment of the present invention, the controller qualifies one or more gaming terminals each in which the number of gaming media bet on the previous race by pseudo racehorses is equal to or more than a certain number of gaming media to participate in the bonus game.

According to the embodiment, one or more gaming terminals each in which the number of gaming media bet on the previous race by pseudo racehorses is equal to or more than a certain number of gaming media are qualified to participate in the bonus game. Therefore, the gaming machine can provide to a player playing at each gaming terminal an incentive that the player bets equal to or more than the certain number of gaming media on a race.

In order to achieve the object, the present invention provides a gaming machine that repeats a unit game in which a race by pseudo racehorses is executed and a prize is provided based on order of arrival for the pseudo racehorse, comprising: a display that displays the race by pseudo racehorses; gaming terminals that are arranged around the display and allow players to participate in the race by pseudo racehorses; a counter that accumulates a part of gaming media bet on the race by pseudo racehorses as a bonus count value when the players participate in the race by pseudo racehorses using the gaming terminals; and a controller that (a) randomly selects a unit game as a bonus game from among unit games; (b) qualifies one or more gaming terminals which meet a certain condition to participate in the bonus game; (c) assigns one or more pseudo racehorses which run in the bonus game to each qualified gaming terminal; and (d) provides a whole or part of bonus count value to one or more gaming terminals to which one or more pseudo racehorses reaching any of first to N-th (N≧1) places in the bonus game are assigned.

According to the present invention, a part of gaming media bet on the race by pseudo racehorses is accumulated as a bonus count value and a unit game is randomly selected from among unit games as a bonus game. In the bonus game, one or more pseudo racehorses which run in the bonus game are assigned to each qualified gaming terminal. If one or more pseudo racehorses assigned to one or more gaming terminals reaches any of first to N-th (N≧1) in the bonus game, a whole or part of bonus count value is provided to the one or more gaming terminals. Therefore, the gaming machine can provide to a player playing at each gaming terminal an opportunity that the player obtains more gaming media.

In a preferred embodiment of the present invention, the gaming machine further comprises a side game device that executes a side game differing from the race by pseudo racehorses, wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

According to the embodiment, one or more gaming terminals not participating in the bonus game can participate in the side game when the bonus game is executed. Therefore, the gaming machine can prevent a player playing a gaming terminal not participating in the bonus game from feeling bored.

In a preferred embodiment of the present invention, the side game includes a sub-game in which each gaming terminal not participating in the bonus game predicts one or more winning pseudo racehorses from among pseudo racehorses to be running in the bonus game.

According to the embodiment, in the sub-game, although a player playing a gaming terminal not participating in the bonus game can not obtain a whole or part of bonus count value, he/she can participate in the bonus game as a normal unit game. Therefore, the gaming machine can prevent a player playing a gaming terminal not participating in the bonus game from feeling bored.

In a preferred embodiment of the present invention, the controller provides parts of bonus count value to one or more gaming terminals to which one or more pseudo racehorses reaching any of first to N-th (N≧1) places are assigned so that a gaming terminal to which a pseudo racehorse reaching a high place is assigned obtains more gaming media.

According to the embodiment, parts of bonus count value are provided to one or more gaming terminals to which one or more pseudo racehorses reaching any of first to N-th (N≧1) places are assigned so that a gaming terminal to which a pseudo racehorse reaching a high place is assigned obtains more gaming media. Therefore, the gaming machine can provide to a player playing a gaming terminal an interest for racehorse which will reach a high place at a race.

In order to achieve the object, the present invention provides a control method of gaming machine that repeats a unit game in which a race by pseudo racehorses is executed and a prize is provided based on order of arrival for the pseudo racehorse, comprising: displaying the race by pseudo racehorses on a display; accumulating a part of gaming media bet on the race by pseudo racehorses as a bonus count value when players participate in the race by pseudo racehorses using gaming terminals; randomly selecting a unit game as a bonus game from among unit games; qualifying one or more gaming terminals which meet a certain condition to participate in the bonus game; assigning one or more pseudo racehorses which run in the bonus game to each qualified gaming terminal; and providing a whole or part of bonus count value to one or more gaming terminals to which one or more pseudo racehorses winning in the bonus game are assigned.

According to the present invention, a part of gaming media bet on the race by pseudo racehorses is accumulated as a bonus count value and a unit game is randomly selected from among unit games as a bonus game. In the bonus game, one or more pseudo racehorses which run in the bonus game are assigned to each qualified gaming terminal. If one or more pseudo racehorses assigned to one or more gaming terminals wins in the bonus game, a whole or part of bonus count value is provided to the one or more gaming terminals. Therefore, the gaming machine can provide to a player playing at each gaming terminal an opportunity that the player obtains more gaming media.

### BRIEF DESCRIPTION OF THE DRAWINGS

FIG. 1 is a first flow chart of a schematic process procedure of a gaming machine according to an exemplary embodiment of the present invention.

FIG. 2 is a second flow chart of the schematic process procedure of the gaming machine according to the exemplary embodiment of the present invention.

FIG. 3 is a perspective view of the gaming machine according to the exemplary embodiment of the present invention.

FIG. 4 is a perspective view of a gaming terminal in the gaming machine according to the exemplary embodiment of the present invention.

FIG. 5 is a network connection diagram of the gaming machine according to the exemplary embodiment of the present invention.

FIG. 6 is a block diagram of a control circuit of a racing game controller in the gaming machine according to the exemplary embodiment of the present invention.

FIG. 7 is a block diagram of a control circuit of the gaming terminal in the gaming machine according to the exemplary embodiment of the present invention.

FIG. 8 is a first flow chart of a process procedure of the gaming machine according to the exemplary embodiment of the present invention.

FIG. 9 is a second flow chart of the process procedure of the gaming machine according to the exemplary embodiment of the present invention.

FIG. 10 is a third flow chart of the process procedure of the gaming machine according to the exemplary embodiment of the present invention.

FIG. 11 is a flow chart of a process for executing a racing game in the gaming machine according to the exemplary embodiment of the present invention.

FIG. 12 is a flow chart of a process for determining a gaming terminal that is eligible to participate in a bonus game in the gaming machine according to the exemplary embodiment of the present invention.

FIG. 13 is a flow chart of a process for determining a gaming terminal that is eligible to participate in a bonus game in the gaming machine according to a modified example of the exemplary embodiment of the present invention.

FIG. 14 is a flow chart of a process for determining a dividend on a bonus game in the gaming machine according to the exemplary embodiment of the present invention.

FIG. 15 is a flow chart of a process for determining a dividend on a bonus game in the gaming machine according to a first modified example of the exemplary embodiment of the present invention.

FIG. 16 is a flow chart of a process for determining a dividend on a bonus game in the gaming machine according to a second modified example of the exemplary embodiment of the present invention.

FIG. 17 is an explanatory diagram of a bet screen displayed on the gaming machine according to the exemplary embodiment of the present invention.

FIG. 18 is an explanatory diagram of a roulette game executed as a side game in the gaming machine according to the exemplary embodiment of the present invention.

FIG. 19 is an explanatory diagram of a bet screen in the roulette game executed as the side game in the gaming machine according to the exemplary embodiment of the present invention.

FIG. 20 is a perspective view of a gaming terminal in the gaming machine according to a modified example of the exemplary embodiment of the present invention.

FIG. 21 is an explanatory diagram of a bonus count value display in the gaming machine according to the exemplary embodiment of the present invention.

FIG. 22 is an explanatory diagram of character information displayed on the gaming machine according to the exemplary embodiment of the present invention.

FIG. 23 is an explanatory diagram of character information displayed on the gaming machine according to the exemplary embodiment of the present invention.

FIG. 24 is an explanatory diagram of character information displayed on the gaming machine according to the exemplary embodiment of the present invention.

FIG. 25 is an explanatory diagram of character information displayed on the gaming machine according to the exemplary embodiment of the present invention.

### DESCRIPTION OF THE PREFERRED EMBODIMENTS

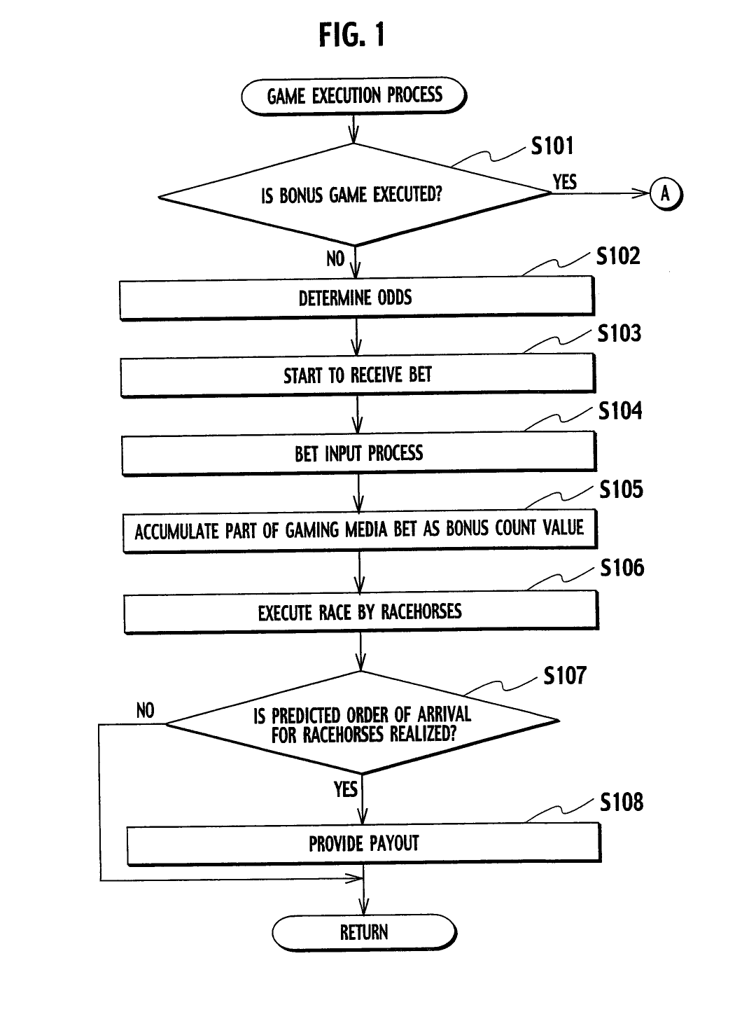

With reference to FIGS. 1 to 25, an exemplary embodiment of the present invention will be described below.

A gaming machine according to the exemplary embodiment accumulates a part of gaming media (e.g., coins or tokens) bet on a normal game as a bonus count value in a counter thereof. Before a bonus game is started, the gaming machine entitles one or more gaming terminals which meet a certain condition to participate in the bonus game. The gaming machine provides a part or a whole of the bonus count value accumulated to one or more gaming terminals to which one or more winning racehorses are assigned, based on a result of the bonus game.

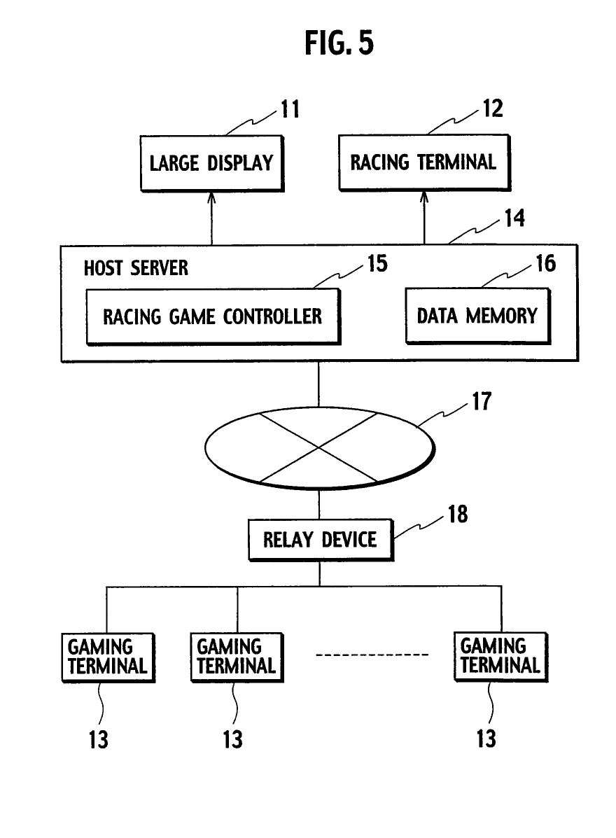

As shown in FIG. 5, a gaming machine 10 comprises a large display 11, a racing terminal 12, gaming terminals 13, a host server 14, a network 17 and a relay device 18. The gaming machine 10 executes a racing game using the large display 11, the racing terminal 12 and the host server 14. Each gaming terminal 13 receives from a player a prediction about order of arrival for racehorses. After executing a racing game, the gaming machine 10 provides a part or a whole of the bonus count value accumulated to one or more gaming terminals 13 which received from one or more players the predicted order of arrival which is realized on the racing game. The host server 14 includes a racing game controller 15 operable to control the execution of racing game and a data memory 16 in which various data on results of past races of each racehorse, a winning rate of each racehorse, and the like are stored. The host server 14 is linked to the large display 11 and the racing terminal 12 and to the gaming terminals 13 via the network 17 and the relay device 18.

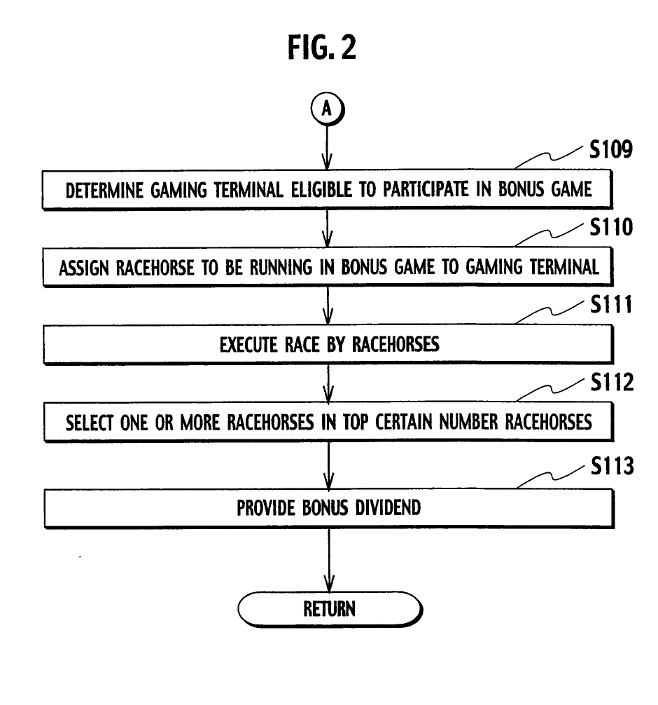

As shown in FIG. 1, in step S101, the racing game controller 15 determines whether or not a bonus game is executed. If the bonus game is not executed (a normal game is executed), the process proceeds to step S102. If the bonus game is executed, the process proceeds to step S109 in FIG. 2.

In step S102, the racing game controller 15 determines racehorses which run in a race and then odds about each bet type such as Win, Quinella, Exacta, Trifecta or Superfecta based on a winning rate of each racehorse determined.

In step S103, the racing game controller 15 starts to receive a bet from each gaming terminal 13. In step S104 (bet input process), each gaming terminal 13 allows a player to bet on each bet type, that is each gaming terminal 13 allows a player to predict order of arrival for the racehorses, and sends bet data to the racing game controller 15.

In step S105, the racing game controller 15 accumulates a part (e.g., 10%) of gaming media bet in each gaming terminal 13 as a bonus count value.

In step S106, the racing game controller 15 executes the race by the racehorses. In the race, racehorse models race on the racing terminal 12. The large display 11 displays the race thereon in cooperation with the race on the racing terminal 12. Namely, the racehorse images on the large display 11 and the racehorse models on the racing terminal 12 are pseudo racehorses.

In step S107, the racing game controller 15 determines whether or not the predicted order of arrival is realized on the race every gaming terminals 13. For example, in a case where a player selects Win as bet type at a corresponding gaming terminal 13 and bets on a racehorse to which the number “5” is assigned, when the racehorse to which the number “5” is assigned reaches a goal first, the racing game controller 15 determines that the corresponding gaming terminal 13 wins on this race. If the predicted order of arrival is realized, the process proceeds to step S108. If the predicted order of arrival is not realized, the process returns to step s101 to start a next race.

In step S108, the racing game controller 15 provides a payout to each winning gaming terminal 13 based on corresponding odds, and then the process returns to step S101 to start a next race.

In a case where the bonus game is executed, as shown in FIG. 2, in step S109, the racing game controller 15 determines one or more gaming terminals 13 that are eligible to participate in the bonus game. For example, the racing game controller 15 determines one or more gaming terminals 13 at which one or more players bet in the previous race.

In step S110, the racing game controller 15 assigns one or more racehorses to one or more gaming terminals 13 determined in step S109. For example, in a case where the number of racehorses is eight and the number of gaming terminals 13 determined in step S109 is eight, the racing game controller 15 assigns one racehorse to one gaming terminal 13.

In step S111, the racing game controller 15 executes a race by the racehorses. In this race, racehorse images race on the large display 11.

In step S112, the racing game controller 15 determines what number each racehorse is and selects one or more racehorses in the top certain number racehorses (e.g., top three racehorses).

In step S113, the racing game controller 15 provides a part of or a whole of the bonus count value accumulated, to one or more winning gaming terminals 13 to which one or more racehorses selected in step S112 are assigned. Then, the process returns to step S101 to start a next race.

Thus, the gaming machine 10 executes one or more bonus games randomly selected in a series of racing games and provides a part or a whole of the bonus count value accumulated to one or more winning gaming terminals 13 in each bonus game. Due to this bonus game, the gaming machine 10 can provide to a player playing at each gaming terminal 13, an opportunity that the player obtains more gaming media.

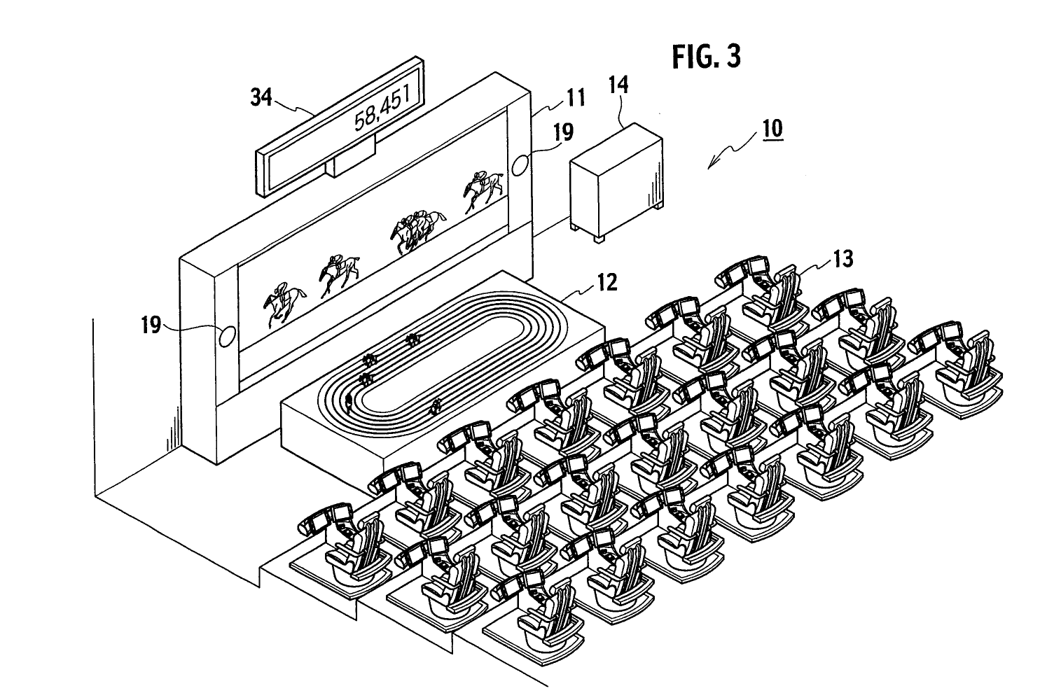

As shown in FIG. 3, the large display 11 includes two speakers 19, 19 for outputting effective sounds at both end portions thereof and a bonus count value display 34 for displaying a bonus count value on the upper end portion thereof. The racing terminal 12 is located in front of the large display 11. The gaming terminals 13 are opposed to the large display 11 via the racing terminal 12. The host sever 14 controls the image display of the large display 11 and the operation of the racing terminal 12.

The large display 11 displays images regarding a race by racehorses thereon when the race is executed. The large display 11 further displays thereon odds of each bet type, images of paddock or breaking of each racehorse which runs in a race, or past races before the race is executed. A racehorse image on the large display 11 is one example of a pseudo racehorse.

The racing terminal 12 executes the same race as the large display 11 displays by racing racehorse models on a track thereof. Namely, when a racing game is executed, the gaming machine 10 provides a situation of race and a result of race to players using images and three-dimensional models. A racehorse model on the racing terminal 12 is one example of a pseudo racehorse.

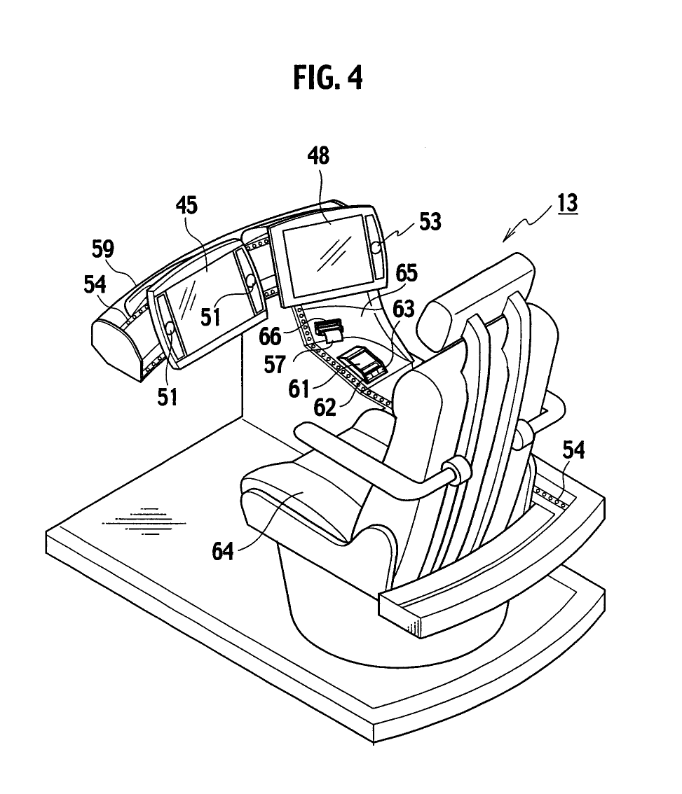

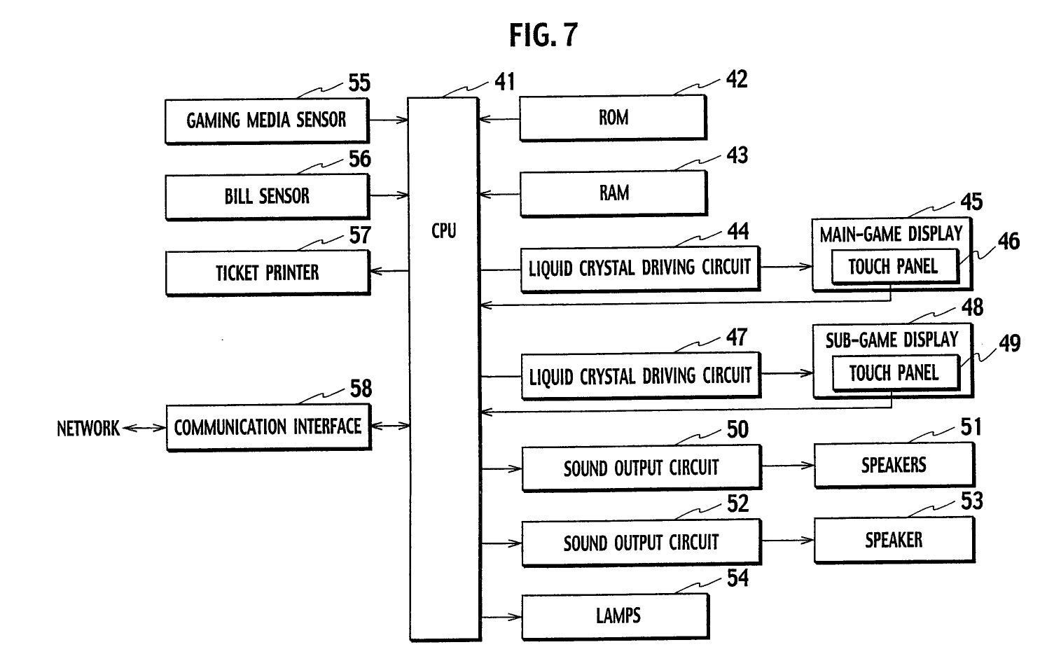

Each gaming terminal 13 can seat a player who will play racing games to be executed continually. Since the gaming terminals 13 are identical to each other, only one gaming terminal 13 is detailed in FIGS. 4 and 7. As shown in FIG. 4, the gaming terminal 13 includes an arm 59, a seat 64 and a control box 65. The arm 59 is mounted in front of the seat 64 and substantially extends along a lateral direction of the seat 64. A player takes the seat 64 when using the gaming terminal 13. The control box 65 is mounted at a right side of the seat 64.

The arm 59 is provided with a main-game display 45 for displaying various images regarding a racing game and a sub-game display 48 for displaying various images regarding a side game other than the racing game. The main-game display 45 is provided with speakers 51, 51 for outputting effective sounds corresponding to images displayed on the main-game display 45 at both end portions (right and left sides) thereof. The sub-game display 48 is provided with a speaker 53 for outputting effective sounds corresponding to images displayed on the sub-game display 48 at one end portion (right side) thereof.

The control box 65 is provided with a ticket printer 57, a gaming media storage box 61, an open button 62, a close button 63 and a bill insertion slot 66. The ticket printer 57 prints out data on payouts. The gaming media storage box 61 allows a player to insert one or more gaming media thereinto. The open button 62 opens a cover of the gaming media storage box 61. The close button 63 closes the cover of the gaming media storage box 61. The bill insertion slot 66 allows a player to insert one or more bills thereinto. The ticket printer 57 and the bill insertion slot 66 are located in front of the gaming media storage box 61.

Lamps 54 are mounted to a side end portion of the control box 65 and upper and lower end portions of the arm 59. For example, the lamps 54 are LEDs. When the gaming terminal 13 wins, the lamps 54 light up or blink to attract to the winning gaming terminal 13 attentions of players who play at other gaming terminals 13.

Next, the internal constitution of the racing game controller 15 will be described below.

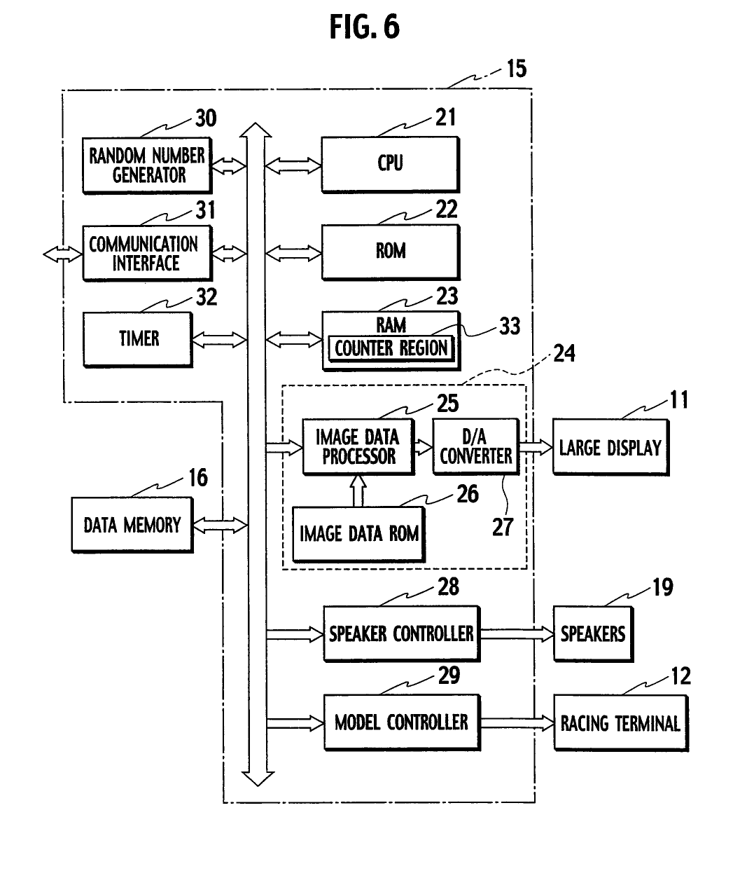

As shown in FIG. 6, the racing game controller 15 includes a CPU 21, a ROM 22, a RAM 23, a display control circuit 24, a speaker controller 28, a model controller 29, a random number generator 30, a communication interface 31 and a timer 32. The CPU 21 controls the whole of racing game controller 15. The ROM 22 permanently stores a racing game program, a system program for executing the racing game program and the like therein. The RAM 23 temporarily stores various data on a racing game. The RAM 23 includes a counter region 33 in which a part of gaming media bet is counted as a bonus count value every time when one or more gaming media are bet at each gaming terminal 13.

The display control circuit 24 generates image data to be displayed on the large display 11 and outputs the image data to the large display 11. The display control circuit 24 includes an image data processor 25, an image data ROM 26 and a D/A converter 27. The image data processor 25 generates image data based on various image data stored in the image data ROM 26. The image data ROM 26 permanently stores the various image data such as background image data and racehorse image data. The image data processor 25 outputs the generated image data to the large display 11 via the D/A converter 27.

The speaker controller 28 generates sound data to be output to the speakers 19, 19 of the large display 11. The model controller 29 controls racehorse models which race on the racing terminal 12 in a racing game.

The random number generator 30 generates a random number used to determine order of arrival for racehorses and a random number used to determine racehorses which run in a racing game when a racing game is executed. The communication interface 31 communicates with each gaming terminal 13 via the network 17. The timer 32 controls a bet reception time.

The racing game controller 15 is linked to the data memory 16. The racing game controller 15 can read from the data memory 16 data such as a result of past races for each racehorse and a winning rate of each racehorse which are stored in the data memory 16. Also, the racing game controller 15 can write data such as a result of new race for each racehorse to the data memory 16.

Next, the internal constitution of the gaming terminal 13 will be described below.

As shown in FIG. 7, the gaming terminal 13 includes a CPU 41, a ROM 42, a RAM 43, a liquid crystal driving circuit 44, the main-game display 45, a liquid crystal driving circuit 47, the sub-game display 48, a sound output circuit 50, the speakers 51, 51, a sound output circuit 52, the speaker 53, the lamps 54, a gaming media sensor 55, a bill sensor 56, the ticket printer 57 and a communication interface 58. The CPU 41 controls the whole of gaming terminal 13. The ROM 42 permanently stores a system program for working the gaming terminal 13 and the like therein. The RAM 43 temporarily stores various data on the execution of program.

The liquid crystal driving circuit 44 generates image data to be displayed on the main-game display 45 and outputs the generated image data to the main-game display 45. The liquid crystal driving circuit 47 generates image data to be displayed on the sub-game display 48 and outputs the generated image data to the sub-game display 48.

The main-game display 45 is provided with a touch panel 46 on a display screen thereof. A player can enter various pieces of information such as requests for displaying images of one or more racehorses which he/she will bet on, the number of gaming media bet, a paddock image and a breaking image, by touching the touch panel 46.

The sub-game display 48 is provided with a touch panel 49 on a display screen thereof. A player can enter various pieces of information on the execution of sub-game by touching the touch panel 49.

The sound output circuit 50 generates effective sounds related to images displayed on the main-game display 45 and outputs the generated effective sounds to the speakers 51, 51. The sound output circuit 52 generates effective sounds related to images displayed on the sub-game display 48 and outputs the generated effective sounds to the speaker 53.

The gaming media sensor 55 detects one or more gaming media inserted into the gaming media storage box 61 shown in FIG. 4. The bill sensor 56 detects one or more bills inserted into the bill insertion slot 66. The ticket printer 57 prints out data on the number of current credits. The communication interface 58 communicates with the host server 14 via the network 17.

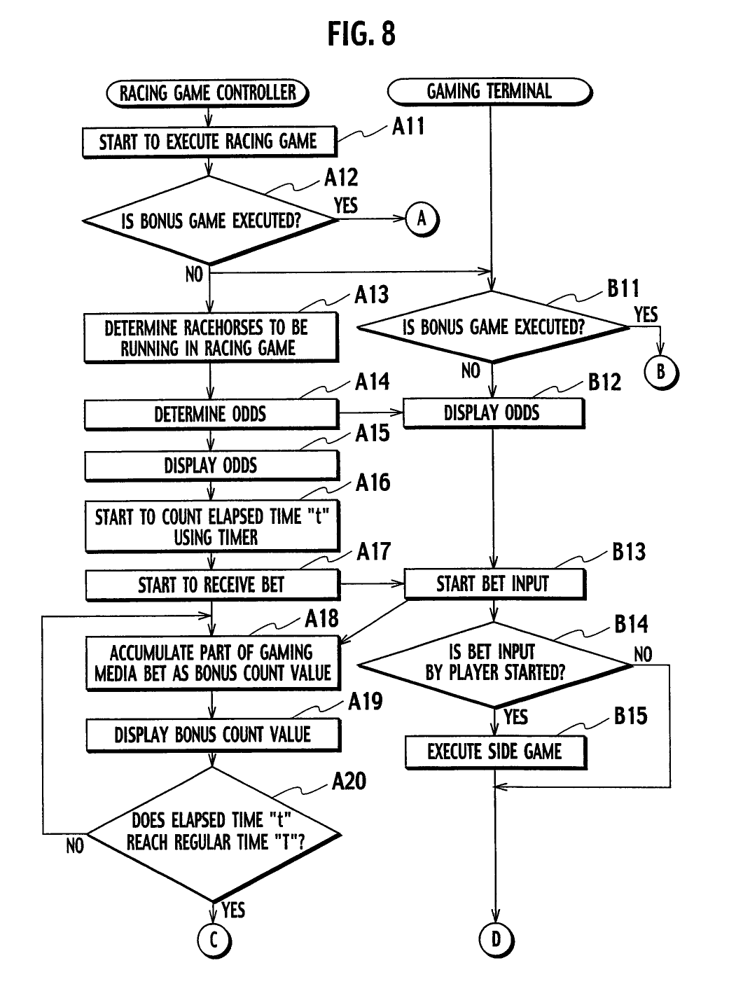

Next, a process procedure of the gaming machine will be described below with reference to FIGS. 8 to 10.

In step A11, the racing game controller 15 starts to execute a racing game.

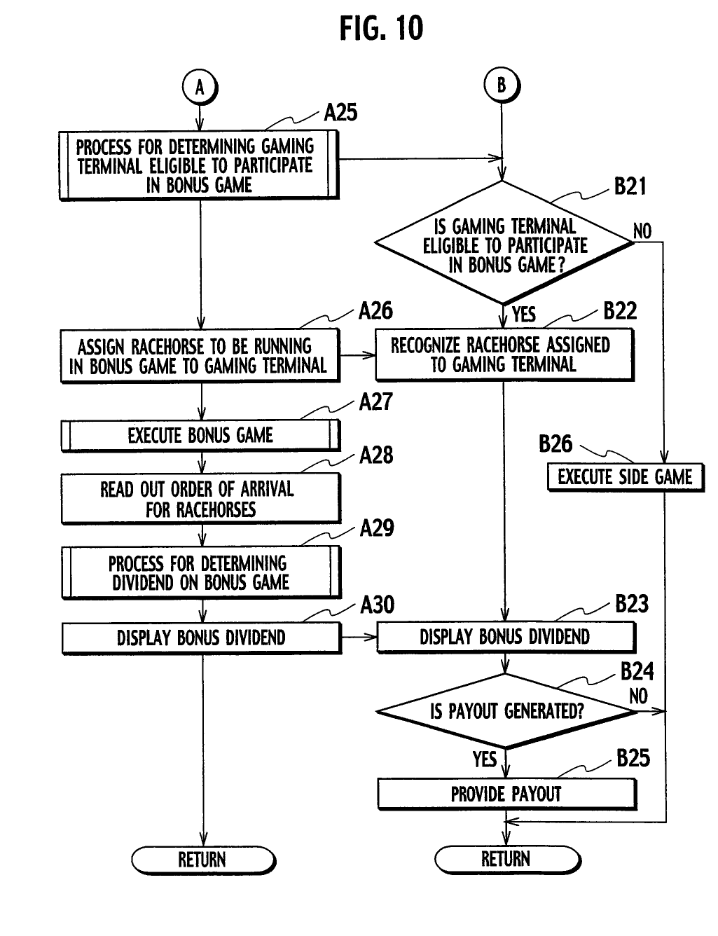

In step A12, the racing game controller 15 determines whether or not a bonus game is executed. The execution of bonus game is randomly determined. For example, when the racing game controller 15 executes racing games repeatedly, the bonus game is executed at about 1% of the racing games. If the bonus game is not executed (a normal game is executed), the racing game controller 15 sends information indicating that the normal game is executed to each gaming terminal 13 and the process proceeds to steps B11 and A13. If the bonus game is executed, the racing game controller 15 sends information indicating that the bonus game is executed to each gaming terminal 13 and the process proceeds to step A25 shown in FIG. 10.

In step B11, each gaming terminal 13 determines whether or not a bonus game is executed based on the sent information. If the normal game is executed, the process proceeds to step B12. If the bonus game is executed, the process proceeds to step B21 shown in FIG. 10.

In step A13, the racing game controller 15 determines racehorses which run in the current racing game. In this process, the racing game controller 15 randomly selects racehorses (eight racehorses in this embodiment), which run in the current racing game, from among a plurality of racehorses stored in the data memory 16 based on a random number generated in the random number generator 30. In this case, the racing game controller 15 assigns the numbers “1” to “8” to the eight racehorses selected. It is noted that the racing game controller 15 may select racehorses which run in the current racing game, in rotation.

In step A14, the racing game controller 15 determines odds about each bet type such as Win, Quinella, Exacta, Trifecta or Superfecta based on a winning rate of each racehorse which runs in the current racing game. Namely, the racing game controller 15 sets odds for order of arrival of racehorses which include one or more racehorses having a relatively high winning rate as relatively low odds, and odds for order of arrival of racehorses which include one or more racehorses having relatively low winning rate as relatively high odds. The racing game controller 15 sends the odds data to each gaming terminal 13 via the communication interface 31, the network 17 and the relay device 18.

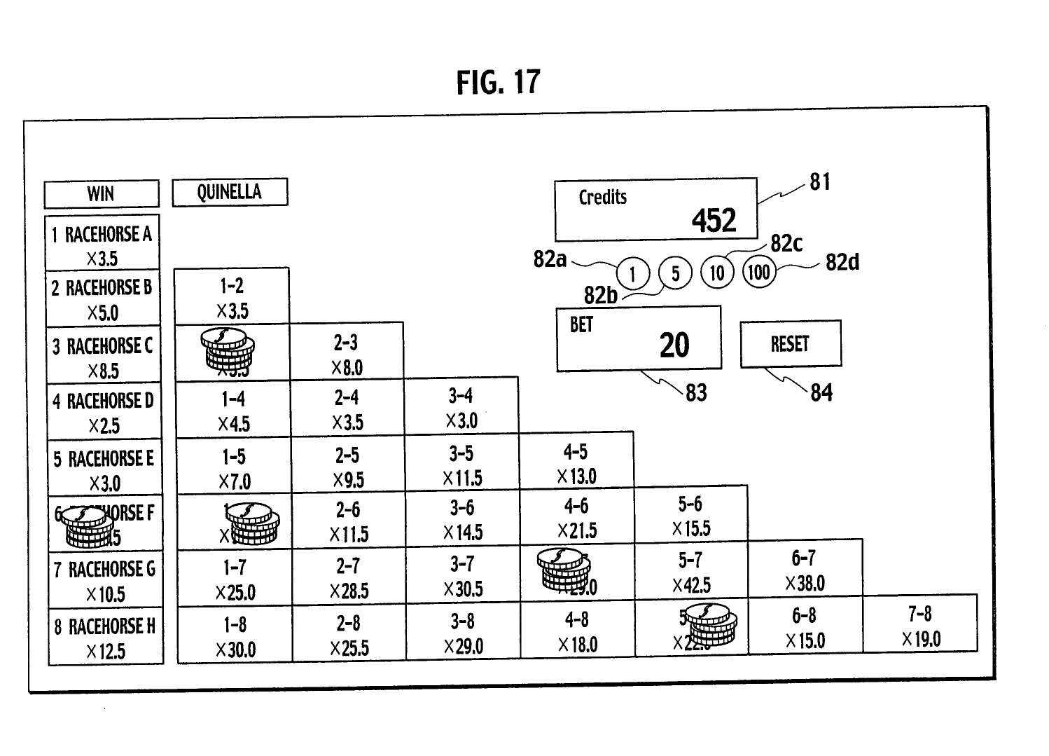

In step B12, each gaming terminal 13 receives the odds data from the racing game controller 15 and display the odds on the main-game display 45. For example, as shown in FIG. 17, a bet screen for Win and Quinella is displayed on the main-game display 45. In this bet screen, odds about Win of “racehorse A” and Quinella of “racehorse B” and “racehorse C” are “3.5 fold” and “8.0 fold”. A player can get to know the odds by watching this bet screen.

In step A15, the racing game controller 15 sends odds data determined in step A14 to the large display 11 via the display control circuit 24 to display the odds on the large display 11.

In step A16, the racing game controller 15 starts to count an elapsed time t using the timer 32.

In step A17, the racing game controller 15 starts to receive bets on each bet type in the current racing game.

In step B13, each gaming terminal 13 starts a bet input. More specifically, a player operates the touch panel 46 to bet on each bet type (predict order of arrival for racehorses) while watching odds displayed on the bet screen in the main-game display 45. As shown in FIG. 17, in addition to the bet screen, the main-game display 45 displays a credit-number display box 81, gaming media selection buttons 82a to 82d, a bet-number display box 83 and a reset button 84 thereon.

The number of credits (gaming media) accumulated in each gaming terminal 13 is displayed in the credit-number display box 81. The number of gaming media bet on a racing game is displayed in the bet-number display box 83. The number of gaming media bet on a racing game is increased every time when a player touches each of the gaming media selection buttons 82a to 82d. For example, if the player touches the gaming media selection button 82b, the number of gaming media bet is increased by “5”. If the player touches the gaming media selection button 82c, the number of gaming media bet is increased by “10”. Thus, a player can select the desired number of gaming media bet by touching each of the gaming media selection buttons 82a to 82d. When a player predicts order of arrival for racehorses and operates the touch panel 46 to select a desired box in each bet type after determining the number of gaming media bet, the determined number is bet on the desired box. For example, if the player touches a box “1-3” in Quinella on the bet screen when “20” is displayed on the bet-number display box 83, twenty gaming media are bet on the box “1-3”. The reset button 84 is used for canceling a bet to reset the number of gaming media bet on a racing game to “0”.

In step A18 of FIG. 8, the racing game controller 15 accumulates a part (e.g. 10%) of gaming media bet on the current racing game as a bonus count value according to the bet input at each gaming terminal 13, and stores the bonus game value in the counter 33.

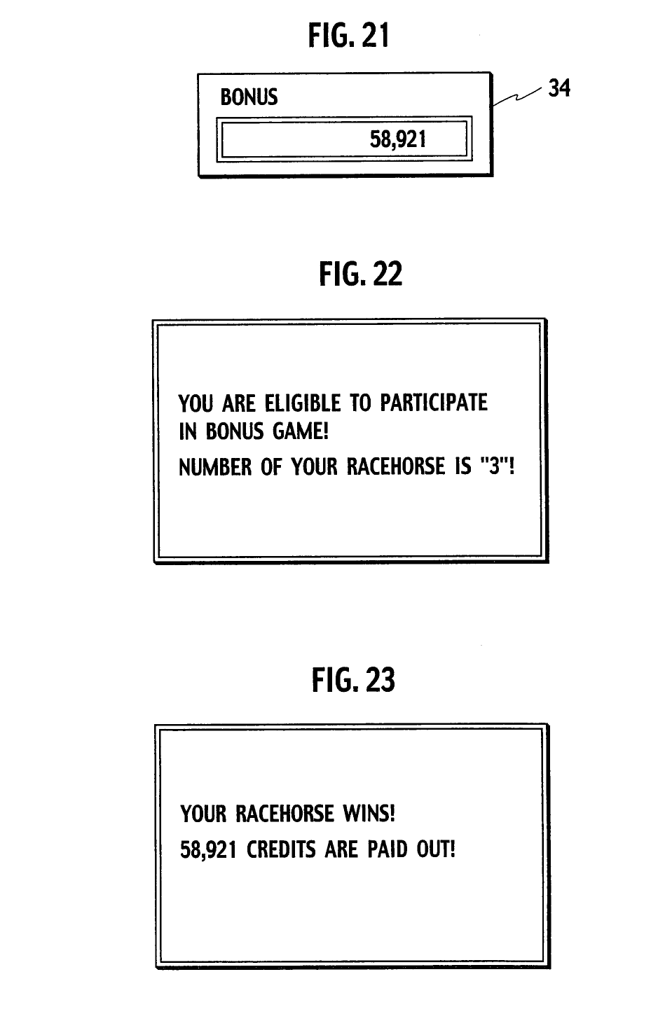

In step A19, the racing game controller 15 displays the bonus count value stored in the counter 33 on the bonus count value display 34. A player who participates in a racing game at each gaming terminal 13 can easily recognize a current bonus count value by watching the bonus count value display 34. For example, as shown in FIG. 21, “58,921” is displayed on the bonus count value 34 as a bonus count value.

In step A20, the racing game controller 15 determines whether or not the elapsed time t counted in the timer 32 reaches a regular time T (e.g., 30 sec.) previously determined. If the elapsed time t reaches the regular time T, the process proceeds to step A21. If the elapsed time t does not reach the regular time T, the process returns to step A18.

In step B14, each gaming terminal 13 determines whether or not a bet input by a player is started. If the bet input is started, the process proceeds to step B15. If the bet input is not started, the process proceeds to step B16.

In step B15, each gaming terminal 13 allows a player to play a side game. The side game is a game other than a racing game and is played on the sub-game display 48 shown in FIG. 4.

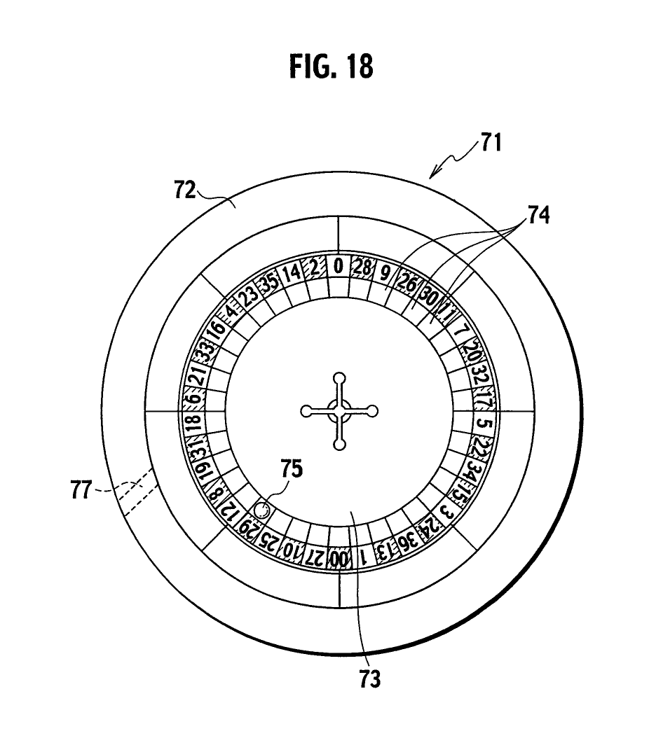

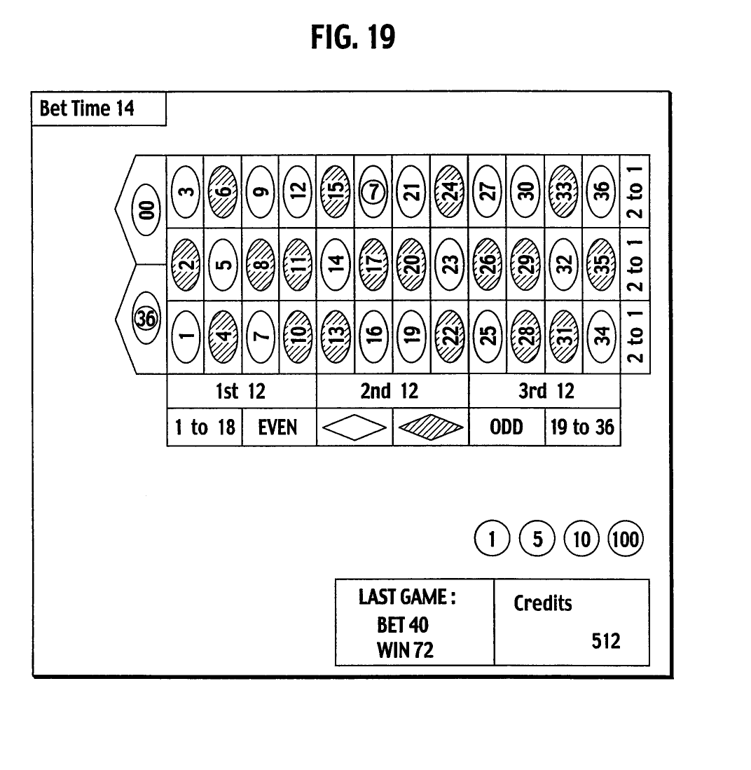

FIG. 18 shows a roulette game which is one example of the side game. FIG. 19 shows a bet screen for the roulette game. As shown in FIG. 18, a roulette game 71 is executed according to the following steps: (1) rotating a roulette wheel 73 with respect to a frame body 72; (2) throwing-in a ball 75 from a boll throw-in slot 77; and (3) determining a dividend according to a number assigned to one of number pockets 74 in which the ball 75 is received. The roulette game 71 is displayed and executed on the sub-game display 48.

As shown in FIG. 19, the bet screen for the roulette game is displayed on the sub-game display 48. A player can bet on a desired number on the bet screen by touching the touch panel 49. After the player bet on one or more numbers, the roulette game 71 is displayed and executed on the sub-game display 48. If a number assigned to one of the number pockets 74 in which the ball 75 is received coincides with the number bet on the bet screen, one or more game media corresponding to an associated dividend is paid out. Thus, when a player bets in a racing game, he/she can play the side game (e.g. roulette game). Accordingly, a player who has finished the bet input does not feel bored while he/she waits a termination time of the bet reception time.

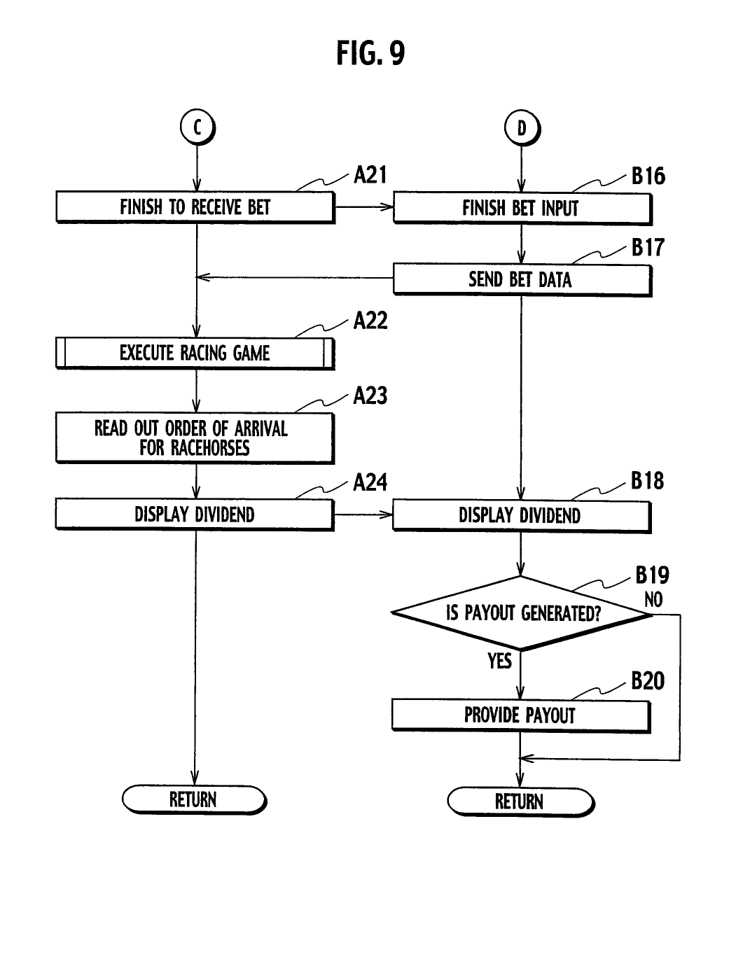

In step A21 of FIG. 9, the racing game controller 15 finishes to receive bets on each bet type in the current racing game. More specifically, when the regular time T is elapsed from the start of bet reception, the racing game controller 15 finishes the bet reception and sends a signal indicating the end of bet reception to each gaming terminal 13.

In step B16, each gaming terminal 13 receives the signal from the racing game controller 15 and finishes the bet input. In step B17, each gaming terminal 13 sends bet data to the racing game controller 15.

In step A22, the racing game controller 15 executes the racing game. In step A23, the racing game controller 15 reads out order of arrival for racehorses, which ran in the racing game, determined in step A22.

In step A24, the racing game controller 15 calculates a dividend based on the determined order of arrival for racehorses and displays the calculated dividend on the large display 11. For example, dividend data (e.g., Win “5”, dividend “3.0 fold” and Quinella “2-5”, dividend “9.5 fold”) is displayed on the large display 11. The racing game controller 15 further sends the dividend data to each gaming terminal 13.

In step B18, each gaming terminal 13 receives the dividend data from the racing game controller 15 and displays the dividend data on the main-game display 45. Thereby, a player who participates in the current racing game at each gaming terminal 13 can get to know the dividend for the current racing game.

In step B19, each gaming terminal 13 determines whether or not a payout is generated. If the payout is generated, the process proceeds to step B20. If the payout is not generated, the process returns to step B11. In step B20, each gaming terminal 13 provide a payout corresponding to the associated dividend to a player.

In steps A12 and B11 of FIG. 8, if the bonus game is executed, the process proceeds to steps A25 and B21 of FIG. 10.

In step A25, the racing game controller 15 carries out a process for determining one or more gaming terminals 13 that are eligible to participate in a bonus game, from among the gaming terminals 13. Then, the racing game controller 15 sends a process result to each gaming terminal 13.

In step A26, the racing game controller 15 assigns one or more racehorses that run in the bonus game to one or more gaming terminals 13 that are eligible to participate in the bonus game. For example, in a case where the number of gaming terminals 13 that are eligible to participate in the bonus game is eight and the number of racehorses that run in the bonus game is eight, the racing game controller 15 assigns one racehorse to one gaming terminal 13. In this step, the racing game controller 15 may randomly assign one or more racehorses to one or more gaming terminals 13. Also, the racing game controller 15 may set order of priority for one or more gaming terminals 13 and assign one or more racehorses desired for a gaming terminal 13 to the gaming terminal 13, in the order of descending priorities. Then, the racing game controller 15 sends a process result to each gaming terminal 13 that is eligible to participate in the bonus game.

In step B21, each gaming terminal 13 receives the process result from the racing game controller 15 and determines whether or not it is eligible to participate in the bonus game based on the received process result. If it is eligible to participate in the bonus game, the process proceeds to step B22. If it is not eligible to participate in the bonus game, the process proceeds to step B26.

In step B22, each gaming terminal 13 receives the process result from the racing game controller 15 and recognizes one or more racehorses assigned thereto in step A26. Then, each gaming terminal 13 displays information on the process result on the main-game display 45. For example, as shown in FIG. 22, character information “YOU ARE ELIGIBLE TO PARTICIPATE IN BONUS GAME! NUMBER OF YOUR RACEHORSE IS “3”!” is displayed on the main-game display 45, which notifies a player of this gaming terminal 13 of the number of racehorse assigned to him/her in the bonus game.

In step A27, the racing game controller 15 executes the bonus game. A processing flow in step A27 is similar to that of step A22.

In step A28, the racing game controller 15 reads out order of arrival for racehorses in the bonus game, determined in step A27.

In step A29, the racing game controller 15 determines a bonus dividend in the current bonus game based on the order of arrival for racehorses.

In step A30, the racing game controller 15 displays the bonus dividend determined in step A29 on the large display 11 and the process returns to step A11. Also, the racing game controller 15 sends the bonus dividend determined in step A29 to each gaming terminal 13.

In step B23, each gaming terminal 13 receives the bonus dividend from the racing game controller 15 and displays the bonus dividend on the main-game display 45. Thus, a player of each gaming terminal 13 can recognize the bonus dividend by watching the large display 11 or the main-game display 45.

In step B24, each gaming terminal 13 determines whether or not a payout is generated based on order of arrival for a racehorse assigned thereto. If the payout is generated, the process proceeds to step B25. If the payout is generated, the process returns to step B11. In step B25, each gaming terminal 13 provides a payout to a player based on the bonus dividends and the process returns to step B11.

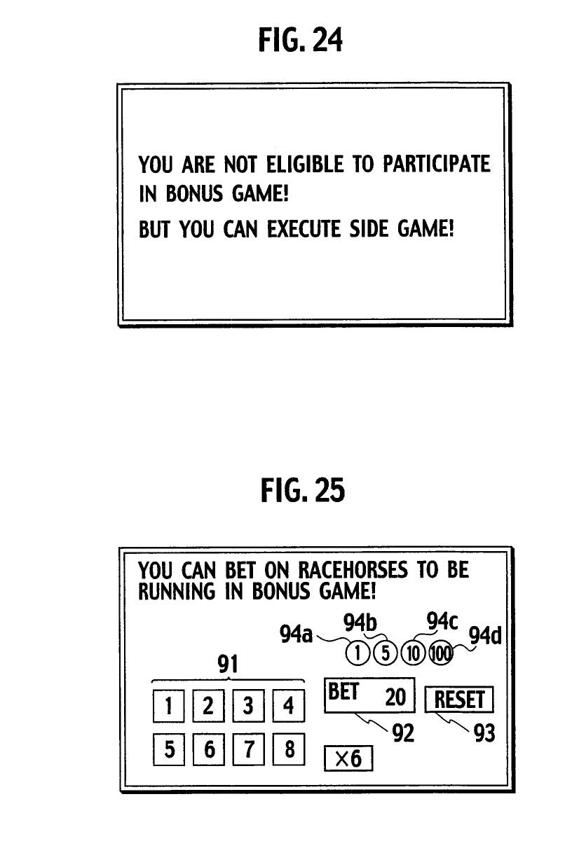

In step B26, each gaming terminal 13 executes a side game. In this step, for example, as shown in FIG. 24, character information “YOU ARE NOT ELIGIBLE TO PARTICIPATE IN BONUS GAME! BUT YOU CAN EXECUTE SIDE GAME!” is displayed on the main-game display 45, which notifies a player of this gaming terminal 13 of an execution of the side game.

In this step, each gaming terminal 13 executes a game such as a roulette game other than a racing game as a side game, using the sub-game display 48.

It is noted that a player may bet on racehorses that run in the bonus game as a side game. In this case, as shown in FIG. 25, character information “YOU CAN BET ON RACEHORSES TO BE RUNNING IN BONUS GAME” is displayed on the sub-game display 48. Further, each gaming terminal 13 displays racehorse-number boxes 91, a bet-number display box 92, a reset button 93 and gaming media selection buttons 94a to 94d on the sub-game display 48. For example, a player can bet on one of eight racehorses to which racehorse-numbers “1” to “8” are assigned. More specifically, the player can predict order of arrival for racehorses in the side game by touching the gaming media selection buttons 94a to 94d to set the desired number of gaming media to be bet in the bet-number display box 92 and touching one or more desired racehorse-number boxes 91. In this embodiment, all odds are set to “6 fold”. Thus, even a gaming terminal 13 that is not eligible to participate in a bonus game can play a game in which a player predicts order of arrival for racehorses to be running in the bonus game.

Next, the process for executing the racing game in step A22 (or the bonus game in step A27) will be described below.

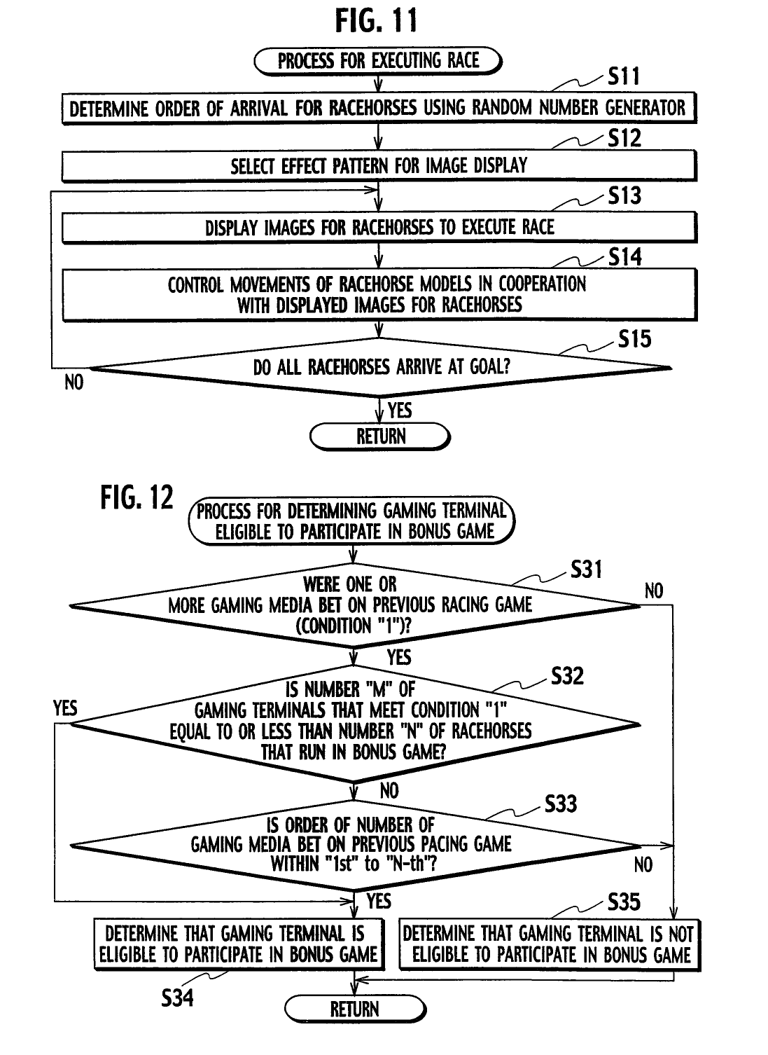

As shown in FIG. 11, in step A11, the racing game controller 15 determines the order of arrival for racehorses in this racing game based on a random number generated in the random number generator 30.

In step S12, the racing game controller 15 selects an effect pattern for image display based on the order of arrival for each racehorse determined in step A11. More specifically, the image data processor 25 generates an effect image for each racehorse from start to finish of this racing game, based on background image data, racehorse image data and the like stored in the image data ROM 26.

In step S13, the racing game controller 15 displays images for this racing game on the large display 11 based on each effect image generated in step S12 to execute the racing game on the large display 11.

In step S14, the racing game controller 15 causes the model controller 29 to control the movement of each racehorse model based on each effect image generated in step S12, in cooperation with the image display in step S13, to execute the racing game on the racing terminal 12. Thereby, the movement of each racehorse displayed on the large display 11 is matched with that of each racehorse moving on the racing terminal 12.

In step S15, the racing game controller 15 determines whether or not all racehorses arrive at the goal. If all racehorses arrive at the goal, the process proceeds to step A23 or A28. If all racehorses do not arrive at the goal, the process returns to step S13.

Next, the process for determining a gaming terminal that is eligible to participate in the bonus game in step A25 will be described below.

As shown in FIG. 12, in step S31, the racing game controller 15 determines whether or not one or more gaming media are bet on the previous racing game in each gaming terminal 13 (condition “1”). If one or more gaming media are bet, the process proceeds to step S32. If one or more gaming media are not bet, the process proceeds to step S35.

In step S32, the racing game controller 15 compares the number M of gaming terminals 13 that meet the condition “1” with the number N of racehorses that run in the bonus game after determining the condition “1” for all gaming terminals 13. Then, the racing game controller 15 determines whether or not the number M is equal to or less than the number N (M≦N). If the number M is equal to or less than the number N, the process proceeds to step S34. If the number M is more than the number N, the process proceeds to step S33.

In step S33, the racing game controller 15 arranges the numbers of gaming media bet on the previous racing game in order of the amount bet, with respect to all gaming terminals 13 that meet the condition “1”. Then, the racing game controller 15 determines whether or not the order of the number of gaming media bet in each gaming terminal 13 that meet the condition “1” is within 1st to N-th. If the order is within 1st to N-th, the process proceeds to step S34. If the order is not within 1st to N-th, the process proceeds to step S35.

For example, in a case where the number N of racehorses that run in the bonus game is eight and the number M of gaming terminals 13 that participate in the bonus game that meet the condition “1” is ten, the racing game controller 15 can not assign one racehorse to each gaming terminal 13. For this reason, the racing game controller 15 arranges the numbers of gaming media bet on the previous racing game in order of the amount bet, with respect to ten gaming terminals 13, and then selects eight gaming terminals 13 of which the order is within first to eighth, from among ten gaming terminals 13. The selected eight gaming terminals are eligible to participate in the bonus game and the non-selected two gaming terminals are not eligible to participate in the bonus game.

Instep S34, the racing game controller 15 determines that the gaming terminal 13 is eligible to participate in the bonus game, and the process proceeds to steps A26 and B21. In this case, the racing game controller 15 can assign one or more racehorses that run in the bonus game to each gaming terminal 13.

In step S35, the racing game controller 15 determines that the gaming terminal 13 is not eligible to participate in the bonus game, and the process proceeds to steps A26 and B21.

This leads to an increase in player's motivation to bet more gaming media on a racing game because the racing game controller 15 determines a gaming terminal that is eligible to participate in a bonus game to be randomly executed with reference to the amount of gaming media bet on the previous racing game.

Next, a modified process for determining a gaming terminal that is eligible to participate in a bonus game will be described below.

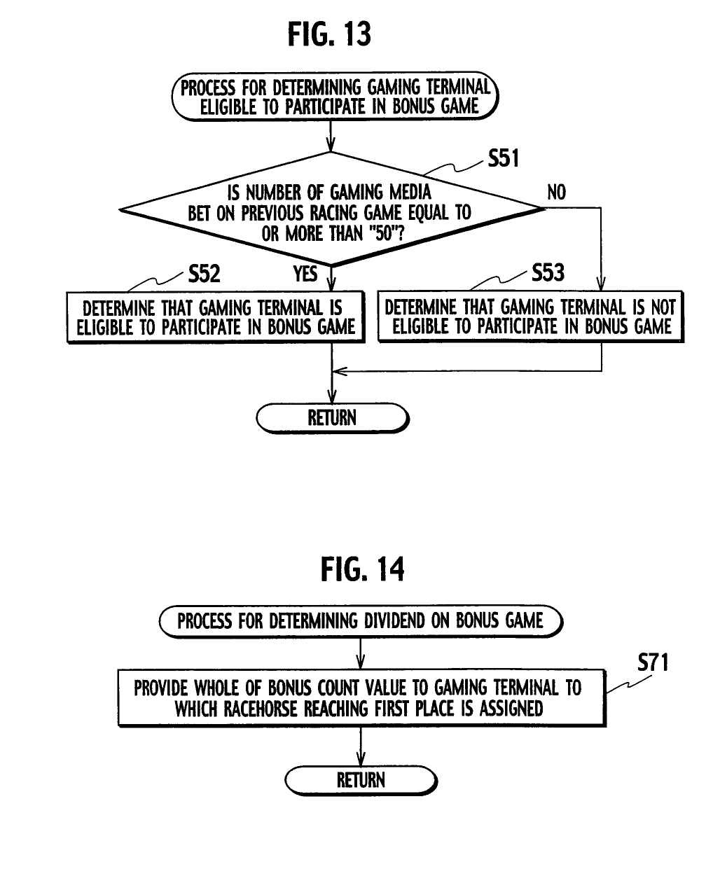

As shown in FIG. 13, in step S51, the racing game controller 15 determines whether or not the amount of gaming media bet on the previous racing game is equal to or more than fifty in each gaming terminal 13. If the amount is equal to or more than fifty, the process proceeds to step S52. If the amount less than fifty, the process proceeds to step S53.

In step S52, the racing game controller 15 determines that the gaming terminal 13 is eligible to participate in the bonus game, and the process proceeds to steps A26 and B21. In step 53, the racing game controller 15 determines that the gaming terminal 13 is not eligible to participate in the bonus game, and the process proceeds to steps A26 and B21.

This leads to an increase in player's motivation to bet more than forty-nine gaming media on a racing game because the racing game controller 15 determines a gaming terminal that is eligible to participate in a bonus game to be randomly executed with reference to the amount of gaming media bet on the previous racing game. It is noted that the threshold of the amount of gaming media bet on the previous racing game may be set to a value other than fifty.

Next, a process for determining a dividend on a bonus game in step A29 will be described below.

As shown in FIG. 14, in step S71, the racing game controller 15 provides a whole of bonus count value stored in the counter region 33 in the RAM 23 to a gaming terminal 13 to which a racehorse that reaches first place is assigned. For example, as shown in FIG. 21, if a bonus count value is “58,921”, the racing game controller 15 provides 58,921 gaming media to the gaming terminal 13. At this time, character information “YOUR RACEHORSE WINS! 58,921 CREDITS ARE PAID OUT!” is displayed on the main-game display 45 of the winning gaming terminal 13, which notifies a player of this gaming germinal 13 of the number of gaming media paid out as a bonus dividend. Thus, the player playing the winning gaming terminal 13 can obtain more gaming media.

Next, a first modified process for determining a dividend on a bonus game will be described below.

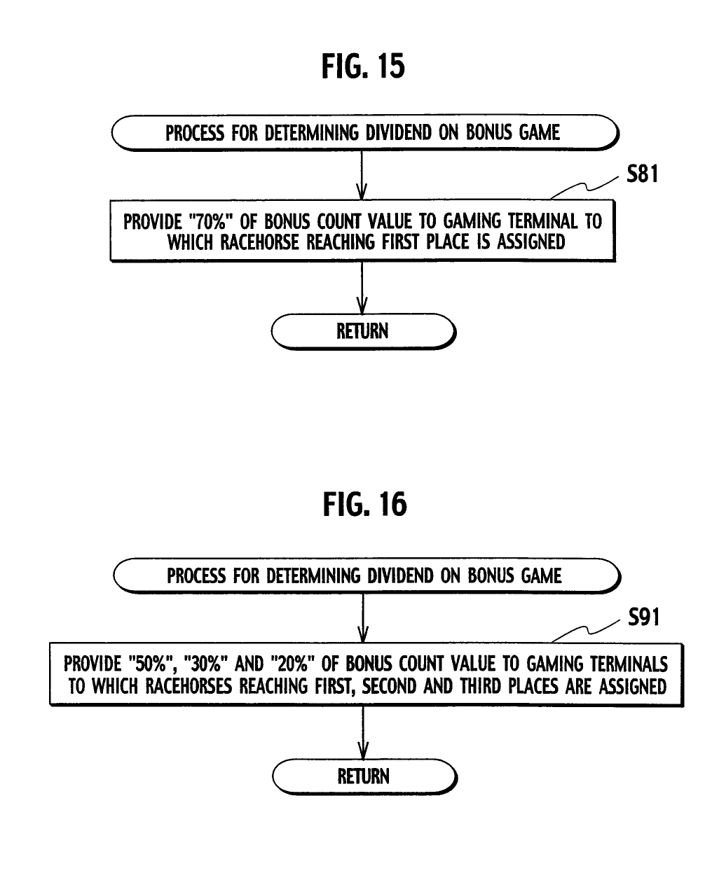

As shown in FIG. 15, in step S81, the racing game controller 15 provides a part (e.g. 70% in this modified example) of bonus count value stored in the counter region 33 in the RAM 23 to a gaming terminal 13 to which a racehorse that reaches first place is assigned. Thus, the player playing the winning gaming terminal 13 can obtain more gaming media.

Next, a second modified process for determining a dividend on a bonus game will be described below.

As shown in FIG. 16, in step S91, the racing game controller 15 provides parts of bonus count value stored in the counter region 33 in the RAM 23 to three gaming terminals 13 to which three racehorses that reach first, second, and third places are assigned respectively. In this modified example, the racing game controller 15 provides 50% of the bonus count value to a gaming terminal 13 to which a racehorse that reaches first place is assigned, 30% of the bonus count value to a gaming terminal 13 to which a racehorse that reaches second place is assigned, and 20% of the bonus count value to a gaming terminal 13 to which a racehorse that reaches third place is assigned. Thus, three players playing these winning gaming terminals 13 can obtain more gaming media. It is noted that the racing game controller 15 may provides parts of bonus count value to two or N (N≧4) gaming terminals 13 to two or N (N≧4) racehorses that reach first and second places, or first, second, third, . . . , N places are assigned.

Thus, the gaming machine according to the exemplary embodiment executes a racing game to be randomly selected from among racing games continuously executed, as a bonus game which differs from a normal game. In the bonus game, the racing game controller 15 determines that one or more gaming terminals 13 that meet a certain condition are eligible to participate in the bonus game and assigns one racehorse to each gaming terminal 13. Then, as a result of the execution of bonus game, the racing game controller 15 provides a whole of or a part of a bonus count value to a gaming terminal 13 to which a racehorse that reaches first place or certain place is assigned. Therefore, the gaming machine according to the exemplary embodiment can provide an opportunity for obtaining more gaming media to a player.

Although the gaming machine 10 of the present invention is described based on the exemplary embodiment shown in FIGS. 1 to 25, the configuration of each element may be replaced by other configuration having the similar function.

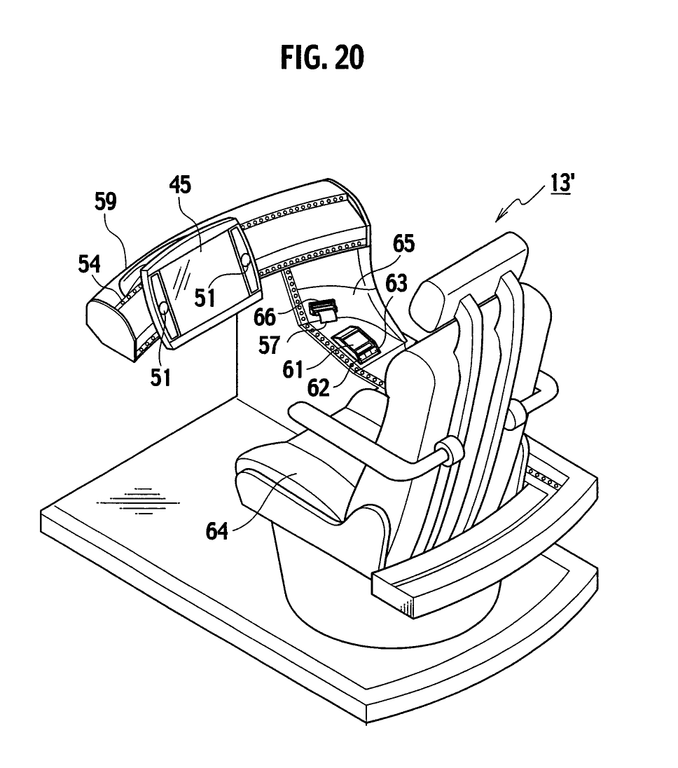

For example, although each gaming terminal 13 includes two displays (the main-game display 45 and the sub-game display 48) in the above-described exemplary embodiment as shown in FIG. 3, each gaming terminal 13 (13′) may include only the main-game display 45 as shown in FIG. 20. In this case, the gaming terminal 13′ can not execute a side-game.

Further, although the racing game controller 15 determines racehorses which run in the current racing game in step A13 of FIG. 8 and the determined racehorses run in the current racing game in step A22 of FIG. 9, the racing game controller 15 may determines racehorses which run in the current racing game in two steps. More specifically, in step A13, the racing game controller 15 tentatively determines racehorses which will run in the current racing game. Then, each gaming terminal 13 bets on the racehorses determined tentatively in steps B13 to B16. In step A22 (in a step before step S11 of FIG. 11), the racing game controller 15 finally determines racehorses which run in the current racing game from among the racehorses determined tentatively, and then the racehorses determined finally run in the current racing game. If a racehorse bet by each gaming terminal 13 does not run in the current game, the racing game controller 15 pays back one or more gaming media bet on the racehorse. This allows a player to feel realistic sensation because there are one or more nonstarters in this gaming system.

Furthermore, in step S34 of FIG. 12, if the number M of gaming terminals 13 that meet the condition “1” is less than the number N of racehorses that run in the bonus game, the racing game controller 15 assigns one desired racehorse to each gaming terminal 13 or assigns one or more desired racehorses to each gaming terminal 13 in order of the amount of gaming media bet.

What is claimed is:

1. A gaming machine that repeats a unit game in which a race by pseudo racehorses is executed and a prize is provided based on order of arrival for the pseudo racehorse, comprising:
a display that displays the race by pseudo racehorses;
gaming terminals that are arranged around the display and allow players to participate in the race by pseudo racehorses;
a counter that accumulates a part of gaming media bet on the race by pseudo racehorses as a bonus count value when the players participate in the race by pseudo racehorses using the gaming terminals; and
a controller that
(a) randomly selects a unit game as a bonus game from among unit games;
(b) qualifies one or more gaming terminals which meet a certain condition to participate in the bonus game;
(c) assigns one or more pseudo racehorses which run in the bonus game to each qualified gaming terminal; and
(d) provides a whole or part of bonus count value to one or more gaming terminals to which one or more pseudo racehorses winning in the bonus game are assigned.

2. The gaming machine according to claim 1, further comprising a side game device that executes a side game differing from the race by pseudo racehorses,
wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

3. The gaming machine according to claim 2, wherein the side game includes a sub-game in which each gaming terminal not participating in the bonus game predicts one or more winning pseudo racehorses from among pseudo racehorses to be running in the bonus game when the bonus game is executed.

4. A gaming machine that repeats a unit game in which a race by pseudo racehorses is executed and a prize is provided based on order of arrival for the pseudo racehorse, comprising:
a display that displays the race by pseudo racehorses;
gaming terminals that are arranged around the display and allow players to participate in the race by pseudo racehorses;
a counter that accumulates a part of gaming media bet on the race by pseudo racehorses as a bonus count value when the players participate in the race by pseudo racehorses using the gaming terminals; and
a controller that
(a) randomly selects a unit game as a bonus game from among unit games;
(b) qualifies one or more gaming terminals which bet on the previous race by pseudo racehorses to participate in the bonus game;
(c) assigns one or more pseudo racehorses which run in the bonus game to each qualified gaming terminal; and
(d) provides a whole or part of bonus count value to one or more gaming terminals to which one or more pseudo racehorses winning in the bonus game are assigned.

5. The gaming machine according to claim 4, further comprising a side game device that executes a side game differing from the race by pseudo racehorses,
wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

6. The gaming machine according to claim 5, wherein the side game includes a sub-game in which each gaming terminal not participating in the bonus game predicts one or more winning pseudo racehorses from among pseudo racehorses to be running in the bonus game when the bonus game is executed.

7. The gaming machine according to claim 4, wherein the controller qualifies one or more gaming terminals which bet more gaming media on the previous race by pseudo racehorses to participate in the bonus game, when the number of gaming terminals that bet on the previous race is more than the number of pseudo racehorses that run in the bonus game.

8. The gaming machine according to claim 4, wherein the controller qualifies one or more gaming terminals each in which the number of gaming media bet on the previous race by pseudo racehorses is equal to or more than a certain number of gaming media to participate in the bonus game.

9. A gaming machine that repeats a unit game in which a race by pseudo racehorses is executed and a prize is provided based on order of arrival for the pseudo racehorse, comprising:
a display that displays the race by pseudo racehorses;
gaming terminals that are arranged around the display and allow players to participate in the race by pseudo racehorses;
a counter that accumulates a part of gaming media bet on the race by pseudo racehorses as a bonus count value when the players participate in the race by pseudo racehorses using the gaming terminals; and
a controller that
(a) randomly selects a unit game as a bonus game from among unit games;
(b) qualifies one or more gaming terminals which meet a certain condition to participate in the bonus game;
(c) assigns one or more pseudo racehorses which run in the bonus game to each qualified gaming terminal; and
(d) provides a whole or part of bonus count value to one or more gaming terminals to which one or more pseudo racehorses reaching any of first to N-th (N≧1) places in the bonus game are assigned.

10. The gaming machine according to claim 9, further comprising a side game device that executes a side game differing from the race by pseudo racehorses,
wherein the controller allows one or more gaming terminals participating in the race by pseudo racehorses to simultaneously participate in the side game when the race by pseudo racehorses is executed, and allows one or more gaming terminals not participating in the bonus game to participate in the side game when the bonus game is executed.

11. The gaming machine according to claim 10, wherein the side game includes a sub-game in which each gaming terminal not participating in the bonus game predicts one or more winning pseudo racehorses from among pseudo racehorses to be running in the bonus game.

12. The gaming machine according to claim 9, wherein the controller provides parts of bonus count value to one or more gaming terminals to which one or more pseudo racehorses reaching any of first to N-th (N≧1) places are assigned so that a gaming terminal to which a pseudo racehorse reaching a high place is assigned obtains more gaming media.

13. A control method of gaming machine that repeats a unit game in which a race by pseudo racehorses is executed and a prize is provided based on order of arrival for the pseudo racehorse, comprising:
displaying the race by pseudo racehorses on a display;
accumulating a part of gaming media bet on the race by pseudo racehorses as a bonus count value when players participate in the race by pseudo racehorses using gaming terminals;
randomly selecting a unit game as a bonus game from among unit games;
qualifying one or more gaming terminals which meet a certain condition to participate in the bonus game;
assigning one or more pseudo racehorses which run in the bonus game to each qualified gaming terminal; and
providing a whole or part of bonus count value to one or more gaming terminals to which one or more pseudo racehorses winning in the bonus game are assigned.
